(19) United States
(12) Patent Application Publication
(10) Pub. No.: US 2023/0222467 A1
(43) Pub. Date: Jul. 13, 2023

(54) INITIAL ISSUANCE AND SECONDARY DELIVERY SYSTEM FOR NON-FUNGIBLE TOKEN AND ENTITY OF VIRTUAL-REAL COUPLING PRODUCT AND METHOD THEREOF

(71) Applicant: Skychain CO., LTD., Taipei City (TW)

(72) Inventors: Chen-Hsuan WANG, Taipei City (TW); Jiann-Min YANG, Taipei City (TW); Scott MIAU, Taipei City (TW)

(21) Appl. No.: 17/993,979

(22) Filed: Nov. 24, 2022

(30) Foreign Application Priority Data
Jan. 11, 2022 (TW) 111101090

(51) Int. Cl. G06Q 20/12; G06Q 20/38

(52) U.S. Cl. CPC G06Q 20/1235; G06Q 20/389; G06Q 20/3829; G06Q 2220/00

(57) ABSTRACT

An initial issuance and secondary delivery system for a NFT and an entity of a virtual-real coupling product and a method thereof. In the system, a NFT smart contract is deployed on a blockchain network, and a product NFT is generated before or while an initial register function of the NFT smart contract is executed, and the initial register function is permitted to transfer an ownership of the product NFT; when the product performs a secondary transaction, a secondary delivery transmitter host executes a secondary delivery function to set a delivery condition and requests a secondary delivery receiver host to provide an encrypted delivery content; when the product is delivered and the encrypted delivery content satisfies the delivery condition, an ownership of the product NFT is transferred. Therefore, the technical effect of improving consistency between ownerships of a product entity and a product NFT can be achieved.

### CROSS-REFERENCE STATEMENT

The present application is based on, and claims priority from, TAIWAN Patent Application Serial Number 111101090, filed Jan. 11, 2022, the disclosure of which is hereby incorporated by reference herein in its entirety.

### BACKGROUND

### 1. Technical Field

The present invention relates to an issuance and delivery system and a method thereof, and more particularly to an initial issuance and secondary delivery system for non-fungible token (NFT) and entity of a virtual-real coupling product and a method thereof.

### 2. Description of the Related Art

In recent years, with the popularity and vigorous development of blockchain technology, the applications of NFT are also rapidly developed in addition to homogenized tokens such as Bitcoin and Ethereum.

In general, NFT is a data unit stored on a blockchain and having unique, so it is often applied to unique items, for example, NFT can be applied on artwork as a proof of an ownership. When a physical product and its corresponding NFT exist at the same time, the physical product and the NFT are regarded as a virtual-real coupling product, where the virtual part is the digitized NFT and the real part is the physical product. When an ownership of the virtual-real coupling product is transferred because of an initial transaction or a secondary transaction, the ownerships of the entity and the NFT should be transferred together. However, in practice, the ownerships of the entity and the NFT are often inconsistent after the transaction; for example, the entity has been delivered but the NFT has not been transferred, or the NFT has been transferred but the entity has not been delivered. Therefore, the virtual-real coupling product may have the problem of inconsistency between ownerships of the entity and the product NFT.

According to above-mentioned contents, what is needed is to develop an improved technical solution to solve the conventional problem that the ownerships of the entity and the product NFT of the virtual-real coupling product may be inconsistent.

### SUMMARY

An objective of the present invention is to disclose an initial issuance and secondary delivery system for a non-fungible token (NFT) and an entity of a virtual-real coupling product and a method thereof, to solve the conventional problem.

In order to achieve the objective, the present invention discloses an initial issuance and secondary delivery system for a non-fungible token (NFT) and an entity of virtual-real coupling product, and the initial issuance and secondary delivery system includes a product issuance host, an initial register host, a secondary delivery transmitter host and a secondary delivery receiver host. The product issuance host is one of nodes of a blockchain network, and includes a deploy module and a production module. The deploy module is configured to deploy a NFT smart contract on the blockchain network, wherein the NFT smart contract includes an initial register function and a secondary delivery function, the initial register function stores a product issuance public-key, and is permitted generate a product NFT corresponding to a product before or while the initial register function is executed. The production module is connected to the deploy module, wherein when the product is produced, the production module encrypts necessary data of the product with a product issuance private-key to generate an encrypted product content, embeds the encrypted product content and a product private-key into the product or an entity device corresponding to the product, wherein the necessary data comprises a product public-key. The initial register host is one of the nodes of the blockchain network. When an initial register is performed on the product, initial register host obtains the encrypted product content from the product or the entity device and transmits the encrypted product content to the initial register function, so that the initial register function decrypts the encrypted product content with the stored product issuance public-key to obtain a first decrypted content, and when the product NFT is not produced yet, the initial register function generates the product NFT corresponding to the product, and when the first decrypted content matches the necessary data, the initial register function transfers an ownership of the product NFT to the initial register host, to complete the initial register. The secondary delivery transmitter host is one of the nodes of the blockchain network. When a secondary delivery is performed on the product NFT which has completed the initial register, the secondary delivery transmitter host calls the secondary delivery function to specify the product NFT to be delivered, a secondary delivery receiver address and a delivery timeout as a delivery condition, and request a secondary delivery receiver host to provide an encrypted delivery content based on the secondary delivery receiver address. The secondary delivery receiver host is one of the nodes of the blockchain network. After the product or the entity device corresponding to the product is delivered to the secondary delivery receiver host, the secondary delivery receiver host encrypts specification information, which is preset by the secondary delivery function, with a receiver private-key and the obtained product private-key in a sequential order, to generate the encrypted delivery content and transmit the encrypted delivery content to the secondary delivery function, so that the secondary delivery function decrypts the encrypted delivery content with the product public-key and a receiver public-key in a sequential order, to obtain a second decrypted content, and when the second decrypted content matches the specification information and the delivery timeout is not exceeded, it indicates that the delivery condition is satisfied, an ownership of the product NFT is transferred to the secondary delivery receiver host, so as to maintain consistency between ownerships of the product and the product NFT.

In order to achieve the objective, the present invention further discloses an initial issuance and secondary delivery method for a non-fungible token (NFT) and an entity of a virtual-real coupling product, and the initial issuance and secondary delivery method includes steps of: providing a product issuance host, an initial register host, a secondary delivery transmitter host and a secondary delivery receiver host which are nodes of a blockchain network; deploying a NFT smart contract on the blockchain network, by the product issuance host, wherein the NFT smart contract comprises an initial register function and a secondary delivery function, the initial register function stores a product issuance public-key and is permitted to generate a product NFT corresponding to a product before or while the initial register function is executed; when the product issuance host produces the product, encrypting necessary data of the product with a product issuance private-key to generate an encrypted product content, embedding the encrypted product content and a product private-key into the product or an entity device corresponding to the product, wherein the necessary data comprises a product public-key; when an initial register is performed on the product, obtaining the encrypted product content from the product or the entity device and transmitting the encrypted product content to the initial register function, by the initial register host, wherein the initial register function decrypts the encrypted product content with the stored product issuance public-key to obtain a first decrypted content, wherein when the product NFT is not produced yet, the initial register function generates the product NFT corresponding to the product, and when the first decrypted content matches the necessary data, the initial register function transfers an ownership of the product NFT to the initial register host, to complete the initial register; when a secondary delivery is performed on the product NFT which had completed the initial register, setting a current owner of the product NFT as the secondary delivery transmitter host, and calling the secondary delivery function to specify the product NFT to be delivered, a secondary delivery receiver address and a delivery timeout as a delivery condition, and request the secondary delivery receiver host to provide an encrypted delivery content based on the secondary delivery receiver address; after the product or the entity device corresponding to the product is delivered to the secondary delivery receiver host, encrypting specification information, which is preset by the secondary delivery function, with a receiver private-key and the obtained product private-key in sequential order to generate the encrypted delivery content, and transmitting the encrypted delivery content to the secondary delivery function, by the secondary delivery receiver host, wherein the secondary delivery function decrypts the encrypted delivery content with the product public-key and a receiver public-key in sequential order to obtain a second decrypted content, wherein when the second decrypted content matches the specification information and the delivery timeout is not exceeded, it indicates that the delivery condition is satisfied, an ownership of the product NFT is transferred to the secondary delivery receiver host, so as to maintain consistency between ownerships of the product and the product NFT.

According to the above-mentioned system and method of the present invention, the difference between the present invention and conventional technology is that, in the present invention, the NFT smart contract is deployed on the blockchain network, and the product NFT is generated before or while the initial register function of the NFT smart contract is executed, the initial register function is permitted to transfer the ownership of the product NFT when being executed; when the product performs the secondary transaction, the secondary delivery transmitter host executes the secondary delivery function to set the delivery condition and requests the secondary delivery receiver host to provide the encrypted delivery content; when the product is delivered and the encrypted delivery content satisfies the delivery condition, the ownership of the product NFT is transferred.

According to the above-mentioned technical solution, the present invention is able to achieve the technical effect of improving consistency between ownerships of an entity and a product NFT of a virtual-real coupling product.

### BRIEF DESCRIPTION OF THE DRAWINGS

The structure, operating principle and effects of the present invention will be described in detail by way of various embodiments which are illustrated in the accompanying drawings.

FIG. 1 is a block diagram of an initial issuance and secondary delivery system for a non-fungible token (NFT) and an entity of a virtual-real coupling product, according to the present invention.

FIGS. 2A to 2C are flowcharts of an initial issuance and secondary delivery method for a non-fungible token (NFT) and an entity of a virtual-real coupling product, according to the present invention.

FIG. 3A is a schematic diagram of an operation of deploying a NFT smart contract on a blockchain network, according to an application of the present invention.

FIG. 3B is a schematic diagram of an operation of embedding an encrypted content of a product and a product private-key into a product or device when the product is produced, according to an application of the present invention.

FIG. 3C is a schematic diagram of an operation of performing an initial register, according to an application of the present invention.

FIG. 3D is a schematic diagram of an operation of performing a secondary delivery, according to an application of the present invention.

### DETAILED DESCRIPTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

Before illustration of the initial issuance and secondary delivery system for a non-fungible token (NFT) and an entity of a virtual-real coupling product and a method thereof disclosed in the present invention, the terms defined in the present invention will be explained first. In the present invention, the term “entity” refers to a product/goods in physical (tangible, real-world) environment or in virtual reality (VR); the term “virtual-real” can also be referred to as digital-physical; the term “product issuance host” refers to a host used for a production end or an issuance end of a product/goods; the term “initial register host” refers to a host used for an initial register to a product/goods; the term “secondary delivery transmitter host” refers to a host used by a seller (a current owner of a product/goods) for a secondary transaction (that is, a more-than-second-hand transaction) of the product/goods; the term “secondary delivery receiver host” refers to a host used by a buyer for a secondary transaction of a product/goods. The aforementioned secondary transaction can be, but not limited to, a second transaction or a sequence transaction after the second transaction. In addition, the NFT smart contract mentioned in the present invention refers to a smart contract that is deployed on a blockchain network and used to process a token. In practice, a smart contract means a computer program for driving execution commands based on a predetermined condition and transferred information, and particularly, the smart contract is programmed with programming language, such as Solidity, Serpent, LLL, EtherScript, or Sidechain, and the smart contract can include different functions, events and parameter states. For example, an Ethereum smart contract is compiled to obtain binary codes and an application binary interface (ABI), so as to broadcast the smart contract to the blockchain network and wait for a miner to deploy the smart contract in the blockchain to obtain a corresponding address, and so far the smart contract is deployed through the blockchain transaction. Next, each node can execute the smart contract based on the corresponding address, and change a state of the smart contract in the blockchain by different command and detect whether an event is triggered.

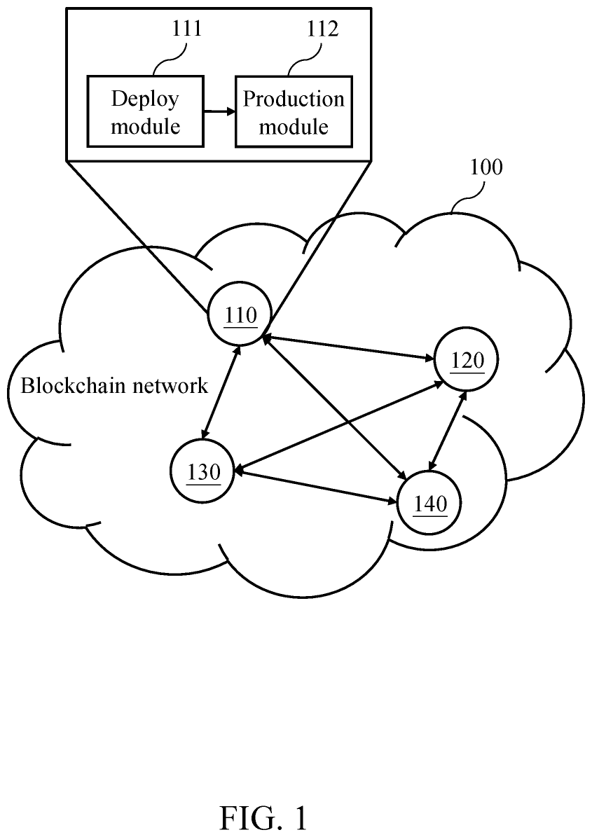

Please refer to FIG. 1, which is a block diagram of an initial issuance and secondary delivery system for a non-fungible token (NFT) and an entity of a virtual-real coupling product, according to the present invention. The initial issuance and secondary delivery system includes a product issuance host 110, an initial register host 120, a secondary delivery transmitter host 130 and a secondary delivery receiver host 140. The product issuance host 110 is one of nodes of a blockchain network 100 and includes a deploy module 111 and a production module 112. The deploy module 111 is configured to deploy a NFT smart contract on the blockchain network 100; for example, the NFT smart contract includes an initial register function and a secondary delivery function. The initial register function is configured to store a product issuance public-key and is permitted to generate a product NFT corresponding to a product before or while the initial register function is executed. For example, the product issuance host 110 can generate the product NFT corresponding to the product when the product is produced or when the initial register host 120 executes the initial register function. In actual implementation, the product issuance host 110 holds the product issuance public-key and the product issuance private-key, and when the NFT smart contract is deployed, the product issuance host 110 stores the product issuance public-key in the initial register function. Therefore, after the NFT smart contract is successfully deployed, the NFT smart contract including the initial register function and the secondary delivery function exists on a blockchain of each node on the blockchain network 100. The initial register function stores the product issuance public-key. The operation of the initial register function will be illustrated in the following paragraphs with reference to the accompanying drawings.

The production module 112 is connected to the deploy module 111. When the product is produced, the production module 112 encrypts necessary data of the product with the product issuance private-key to generate an encrypted product content, generates the product NFT corresponding to the product, and then embeds the encrypted product content and the product private-key into the product or an entity device corresponding to the product. The necessary data can include a product public-key. In actual implementation, the necessary data includes at least one of a serial number, a salt value and a status Boolean value; for example, the necessary data can be recorded in a JSON format, such as {“product private-key”: “A . . . ”, “serial number”:12345, “salt”:“314hrti7135hi8h6i”, “status Boolean value”:1}, and the JSON format of necessary data is encrypted to generate the encrypted product content, and the encrypted product content is embedded into the product; for example, the encrypted content can be converted into a QR codes first and the QR code is embedded on the product, so that a user can scan the QR code to read the encrypted product content. In an embodiment, the encrypted content can be directly embedded into an entity device corresponding to the product, such as a smart IC card or a RFID tag, so that a user can sense the entity device to read the encrypted product content. In practice, the encrypted product content read by the user is decrypted with the product issuance public-key, and when the data is in the JSON format and the status Boolean value is “1”, the encrypted content is determined as valid data.

The initial register host 120 is one of the nodes of the blockchain network 100. In order to perform an initial register on the product, the initial register host 120 obtains the encrypted product content from the product or the entity device, and transmits the encrypted product content to the initial register function, the initial register function decrypts the encrypted product content with the stored product issuance public-key to obtain a first decrypted content; when the product NFT is not produced yet, the initial register function generates the product NFT corresponding to the product. When the first decrypted content matches the necessary data, an ownership of the product NFT is transferred to the initial register host 120, so as to complete the initial register. In other words, when the product NFT is not produced yet, the product NFT can be generated in the NFT smart contract in advance, and the product public-key is store to the product NFT, the ownership of the product NFT is set to the initial register host 120; when the product NFT is generated already before the initial register function is executed, it is not necessary to execute the process of generating the product NFT again.

The secondary delivery transmitter host 130 is one of the nodes of the blockchain network 100. When a secondary delivery is to perform on the product NFT, which has completed the initial register, the secondary delivery transmitter host 130 calls the secondary delivery function to specify the product NFT to be delivered, a secondary delivery receiver address and a delivery timeout as a delivery condition, and request the secondary delivery receiver host 140 to provide an encrypted delivery content based on the secondary delivery receiver address. In actual implementation, the product can perform the secondary transaction for many times before the initial register is to be performed; in order to perform the initial register, the host, which is to perform the initial register, is used as the initial register host 120 to execute the initial register function to complete the initial register, so as to generate and issue the corresponding product NFT or register an owner in the product NFT.

The secondary delivery receiver host 140 is one of the nodes of the blockchain network 100. After the product or the entity device corresponding to the product is delivered to the secondary delivery receiver host 140, the secondary delivery receiver host 140 encrypts specification information preset by the secondary delivery function with a receiver private-key and the obtained product private-key in sequential order to generate the encrypted delivery content, and transmits the encrypted delivery content to the secondary delivery function, so that the secondary delivery function decrypts the encrypted delivery content with the product public-key and a receiver public-key in sequential order to obtain a second decrypted content; when the second decrypted content matches the specification information and the delivery timeout (such as, 2021/11/17 23:59:59) is not exceeded, it indicated that the delivery condition is satisfied, so the ownership of the product NFT is transferred to the secondary delivery receiver host 140, thereby maintaining consistency between the ownerships of the product and the product NFT. In actual implementation, the specification information can include numerical values of 0 and 1, or other string; the specification information can be defined in the secondary delivery function or the delivery condition in plaintext. The delivery timeout can be arbitrarily specified date, time or a combination thereof. In addition, when the second decrypted content does not match the specification information or the delivery timeout is exceeded, it indicates that the delivery condition is not satisfied, and the ownership of the product NFT is prohibited from being changed. When the product is a digital content, the secondary delivery receiver host 140 is permitted to divide the digital content into a plurality of content fragments, perform extraction and offsite storage on at least one of the plurality of content fragments, encrypt the extracted content fragment with the receiver public-key to generate an encrypted extraction content, and write the encrypted extraction content into the NFT smart contract; when the secondary delivery is performed again, the owner of the product NFT can decrypt and recover the encrypted extraction content, or encrypt the encrypted extraction content with the receiver public-key to generate another encrypted extraction content. Particularly, the secondary delivery receiver host 140 has the public key and the private key for completing the secondary delivery, so the present invention can actually provide an additional technical effect, that is, when the virtual part of the virtual-real coupling asset includes another digital content (such as, digital paintings or electronic files) in addition to product NFT, the current owner (that is, the secondary delivery receiver host 140 of the most recent transaction) is permitted to divide the digital content, and extract out a part of the digital content from the original access location (no matter the digital content is stored in a server or the entity part of the virtual-real coupling asset), so as to make the digital content at the original access location become incomplete. Next, the extracted part of the digital content is encrypted with the receiver public-key to generate an encrypted extraction content, and then the encrypted extraction content is written into the NFT smart contract to form or update attributes of the product NFT. In next transaction, the owner of the product NFT, such as a seller (that is, the secondary delivery transmitter host 130) before this transaction or a buyer (that is, the secondary delivery receiver host 140) after this transaction, recovers the encrypted extraction content or encrypts the encrypted extraction content with the receiver public-key to generate another encrypted extraction content, so as to update the attributes of the product NFT. The technical effect achieved by this process is that only the current owner of the product NFT is able to decrypt the encrypted extraction content with the private key to obtain the complete digital content, thereby achieving the third security effect for the digital content in addition to the dual protection of NFT and the entity.

It is to further explain that the transmission between a node of the blockchain network 100 can be performed by wired or wireless manner; for example, the transmission medium of the wired transmission can be copper wire, coaxial cable, optical fiber, twisted pair or the like; the transmission medium of the wireless transmission can be radio waves, microwaves, infrared rays, lasers or the like. In addition, the module and the function mentioned in the present invention can be implemented by various manners, including software, hardware or any combination thereof, for example, in an embodiment, the function can be implemented by software and hardware, or one of software and hardware. Furthermore, the present invention can be implemented fully or partly based on hardware, for example, one or more function of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus. Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

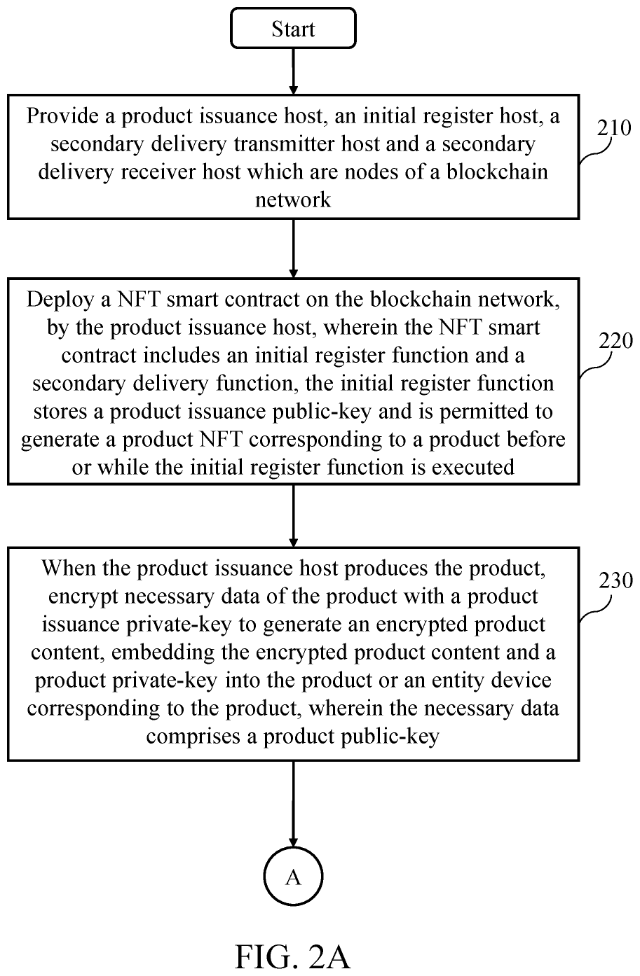

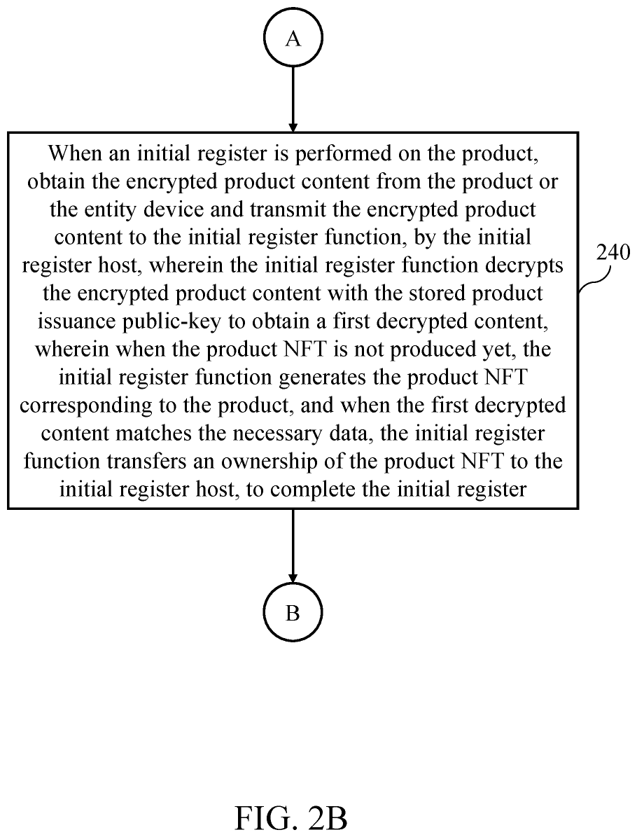

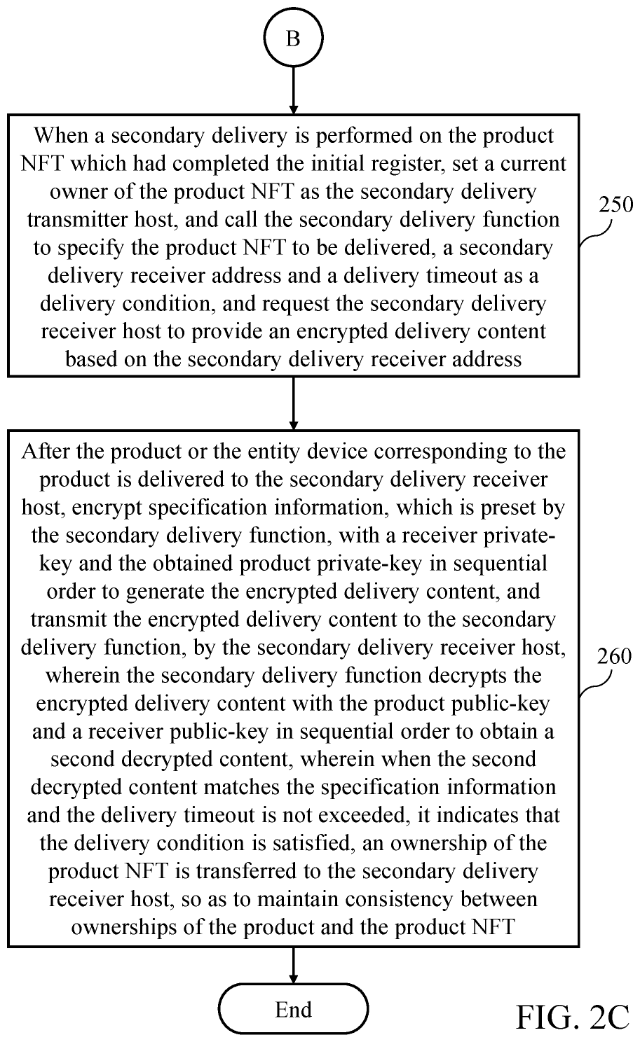

Please refer to FIGS. 2A to 2C, which are flowcharts of an initial issuance and secondary delivery method for a non-fungible token (NFT) and an entity of virtual-real coupling product, according to the present invention. As shown in FIGS. 2A to 2C, the initial issuance and secondary delivery method includes steps 210 to 260. In the step 210, a product issuance host 110, an initial register host 120, a secondary delivery transmitter host 130 and a secondary delivery receiver host 140 which are nodes of a blockchain network 100, are provided. In the step 220, the product issuance host 110 deploys a NFT smart contract on the blockchain network 100, wherein the NFT smart contract includes an initial register function and a secondary delivery function, the initial register function stores a product issuance public-key. In the step 230, when the product issuance host produces the product, encrypting necessary data of the product is encrypted with a product issuance private-key to generate an encrypted product content, and the encrypted product content and a product private-key are embedded into the product or an entity device corresponding to the product, wherein the necessary data includes a product public-key. In the step 240, when an initial register is performed on the product, the initial register host 120 obtains the encrypted product content from the product or the entity device and transmits the encrypted product content to the initial register function, wherein the initial register function decrypts the encrypted product content with the stored product issuance public-key to obtain a first decrypted content, wherein when the product NFT is not produced yet, the initial register function generates the product NFT corresponding to the product, and when the first decrypted content matches the necessary data, the initial register function transfers an ownership of the product NFT to the initial register host 120, to complete the initial register. In the step 250, when a secondary delivery is performed on the product NFT which had completed the initial register, a current owner of the product NFT is set as the secondary delivery transmitter host 130, and the secondary delivery function is called to specify the product NFT to be delivered, a secondary delivery receiver address and a delivery timeout as a delivery condition, and request the secondary delivery receiver host 140 to provide an encrypted delivery content based on the secondary delivery receiver address. In the step 260, after the product or the entity device corresponding to the product is delivered to the secondary delivery receiver host 140, the secondary delivery receiver host 140 encrypts specification information, which is preset by the secondary delivery function, with a receiver private-key and the obtained product private-key in sequential order to generate the encrypted delivery content, and transmits the encrypted delivery content to the secondary delivery function, wherein the secondary delivery function decrypts the encrypted delivery content with the product public-key and a receiver public-key in sequential order to obtain a second decrypted content, wherein when the second decrypted content matches the specification information and the delivery timeout is not exceeded, it indicates that the delivery condition is satisfied, an ownership of the product NFT is transferred to the secondary delivery receiver host, so as to maintain consistency between ownerships of the product and the product NFT. According to the above-mentioned process, the NFT smart contract is deployed in the blockchain network 100, and the product NFT can be generated before or while the initial register function of the NFT smart contract is executed, and the initial register function is permitted to transfer an ownership of the product NFT when being executed; when the product performs secondary transaction, the secondary delivery transmitter host 130 executes the secondary delivery function to set the delivery condition, to request the secondary delivery receiver host 140 to provide the encrypted delivery content, when the product is delivered and the encrypted delivery content satisfies the delivery condition, the ownership of the product NFT is transferred.

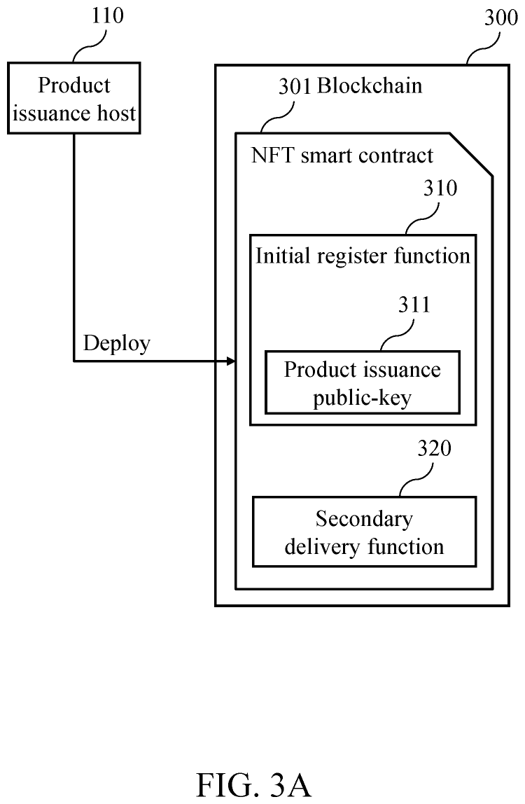

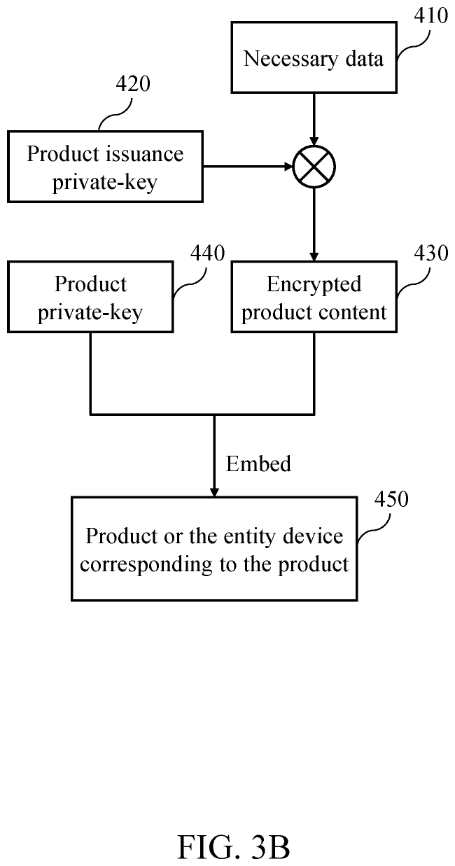

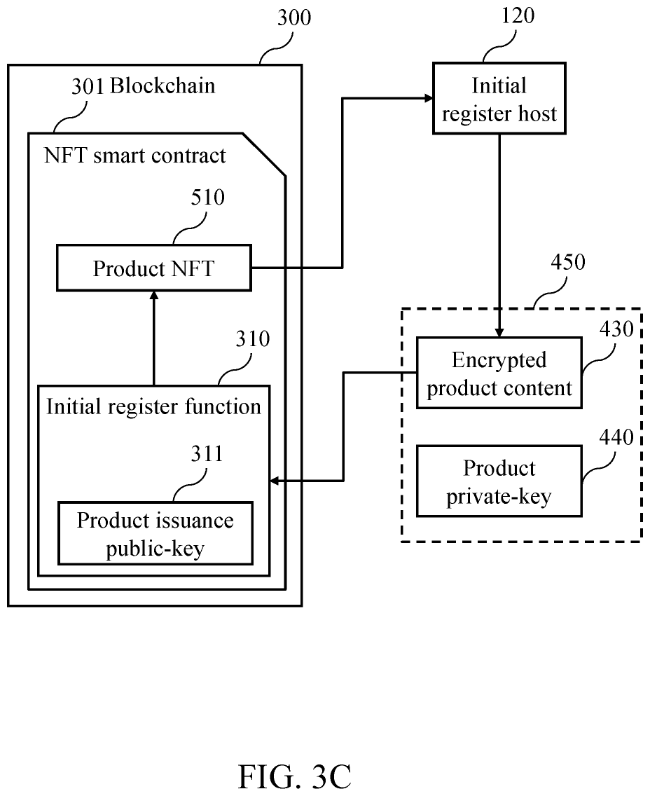

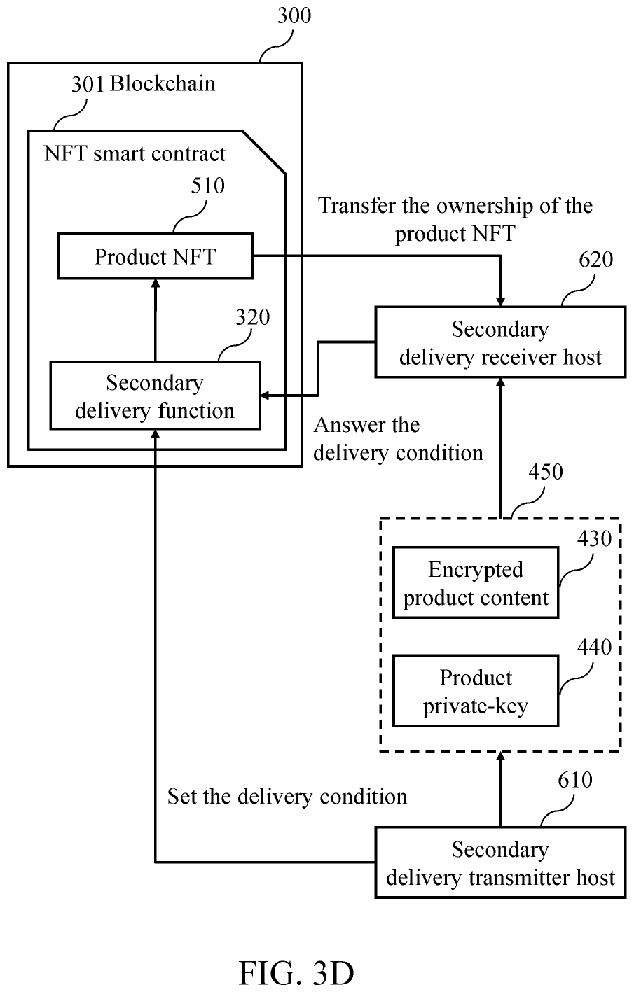

The embodiment manner the present invention will be illustrated in the following paragraphs with reference to FIGS. 3A to 3D. Please refer to FIG. 3A, which is a schematic diagram of an operation of deploying a NFT smart contract on a blockchain network, according to an application of the present invention. In actual implementation, when the product issuance host 110 deploys a NFT smart contract 301 on the blockchain network 100 successfully, a blockchain 300 on each node includes the NFT smart contract 301 including an initial register function 310 and a secondary delivery function 320, and the initial register function 310 includes a product issuance public-key 311.

Please refer to FIG. 3B, which is a schematic diagram of an operation of embedding an encrypted product content and a product private-key when a product is produced, according to an application of the present invention. When the issuance end produces the product (that is, the digital-physical coupling product), the product issuance host 110 encrypts the necessary data 410 of the product with a product issuance private-key 420 to generate an encrypted product content 430, generate a product NFT corresponding to the product, and embed the encrypted product content 430 and the product private-key 440 into the product or the entity device 450 corresponding to the product. The necessary data includes a product public-key. For example, in a condition that the product is an artwork, the encrypted product content 430 and product private-key 440 are embedded in an entity device (such as an IC card) corresponding to the artwork; in a condition that the product is electronic product, the encrypted product content 430 and the product private-key 440 can be directly embedded into the electronic product, for example, the embedding operation can be implemented by burning a disc or writing data the EEPROM or the like by an electronic manner.

As shown in FIG. 3C, which is a schematic diagram of an initial register is executed, according to an application of the present invention. In actual implementation, the initial register is also called a first register; when the buyer obtains the product or the entity device 450 corresponding to the product from the issuance end, the buyer reads the encrypted product content 430 and the product private-key 440 through the initial register host 120, and transmits the encrypted product content 430 to the initial register function 310, the initial register function 310 decrypts the encrypted product content 430 with the stored product issuance public-key 311 to obtain a first decrypted content; when the first decrypted content matches the necessary data 410, the ownership of the product NFT 510 is transferred to the initial register host 120, so as to complete the initial register.

As shown in FIG. 3D, which is a schematic diagram of an operation of performing a secondary delivery, according to an application of the present invention. In actual implementation, the secondary delivery is also called second-hand product transfer; when the secondary delivery is performed on the product which has performed register, the current owner of the product calls the secondary delivery function 320 to set the delivery condition through a secondary delivery transmitter host 610, for example, the secondary delivery function 320 specifies the product NFT to be delivered, a secondary delivery receiver address and a delivery timeout as the delivery condition. The secondary delivery transmitter host 610 requests a secondary delivery receiver host 620 to provide the encrypted delivery content based on the secondary delivery receiver address. After the current owner of the product has delivered the product or the entity device 450 corresponding to the product to the buyer, the buyer encrypts the specification information, which is preset by the secondary delivery function 320, with the receiver private-key and the obtained product private-key 440 to generate the encrypted delivery content in sequential order through the secondary delivery receiver host 620, and the buyer then transmits the encrypted delivery content to the secondary delivery function 320; this transmission can be an answer to the delivery condition. The secondary delivery function 320 decrypts the encrypted delivery content with the product public-key and the receiver public-key in sequential order to obtain a second decrypted content. When the second decrypted content matches with the specification information and the delivery timeout is not exceeded, it indicates that the delivery condition is satisfied, the ownership of the product NFT 510 is transferred to the secondary delivery receiver host 620, so as to maintain consistency between the ownerships of the product NFT and the product.

In an embodiment, the product issued by the artwork issuance company can be a digital artwork, and the product NFT corresponding to the digital artwork has created before issuance of the digital artwork (that is, before the initial register function is executed); the overall process in this condition will be described in the following paragraphs.

In a first step, the artwork issuance company deploys the artwork NFT contract (that is, a NFT smart contract) through the product issuance host 110, the NFT smart contract includes basic functions (such as s function of recording an owner of the artwork) of the NFT, an initial register function and a secondary delivery function. The initial register function can include an artwork issuance company public key (that is, the product issuance public-key).

In a second step, the artwork issuance company prepares the data (that is, the necessary data 410) required for the initial register of the digital artwork, the data includes an artwork public-key (that is, a product public-key), the product issuance host 110 encrypts the necessary data 410 for register with the private key (that is, the product issuance private-key 420) of the artwork issuance company to generate the encrypted content of the artwork (that is, the encrypted product content 430), issues the artwork NFT (that is, the product NFT), and records the artwork public-key in the artwork NFT. A physical IC card for each digital artwork is produced, and the additional information is burned in the physical IC card; the additional information can include the encrypted artwork content and the artwork private-key, that is, the encrypted product content 430 and the product private-key 440.

In a third step, when the owner buying the artwork product obtains the physical IC card and the artwork has not performed initial register yet, the owner can be regarded as an initial register end; the owner can use a reading tool and system provided by the artwork company to obtain an encrypted artwork content from the physical IC card and submit the encrypted artwork content to the initial register function of the artwork NFT contract to perform the initial register of the artwork, through the initial register host 120. The initial register function decrypts the encrypted artwork content with the artwork issuance company public-key and check whether the decrypted content satisfies the specification of the artwork issuance company, that is, the effective artwork public-key matches the public key of the artwork NFT which has not performed initial register and delivered yet. When a result of the check passes, the ownership of the artwork NFT is set to the initial register host 120, which is the holder of the artwork entity IC card. Actually, the artwork issuance company can produce an electronic display cabinet or an electronic showcase in cooperation with the artwork NFT and the physical chip card, the digital artwork can only be displayed on the electronic display cabinet or the electronic showcase; before the artwork is displayed, the identity of the artwork NFT holder must be checked (for example, the holder is checked whether to have the ownership of the artwork NFT) and the IC card must be checked whether to have the correct artwork private-key, so as to achieve the effect of double-checking the artwork NFT and the artwork entity. As a result, the theft stealing the physical IC card or the wallet storing the NFT is unable to show the stolen artwork, and unable to transfer the stolen product because another part is missing.

In a fourth step, because an artwork NFT has the nature of collection and transaction, the artwork NFT can perform a secondary transaction. When a digital artwork NFT is to perform a secondary delivery, the current artwork holder, who can be the initial register end of the previous step or a final holder of the artwork after multiple secondary deliveries, can call the secondary delivery function to specify the artwork NFT to be delivered, the artwork buyer (that is, the secondary delivery receiver host address) and the delivery timeout to set the delivery condition and request the secondary delivery receiver host 620 to provide the encrypted delivery content. The encrypted delivery content is decrypted with the receiver public-key and the artwork public-key in sequential order, and the decryption result is a result defined and specified in plaintext by the secondary delivery function, such as a string “market”.

In a fifth step, after receiving the artwork entity, the secondary delivery receiver encrypts the “market”, specified by the secondary delivery function, with the receiver private-key and the artwork private-key obtained from the physical IC card of the artwork in sequential order to generate the encrypted delivery content; next, the secondary delivery receiver submits the encrypted delivery content to the secondary delivery function. When the secondary delivery function passes the check according to the delivery condition of the artwork NFT and the date “market” is obtained after decryption, the artwork NFT is delivered to the secondary delivery receiver, so as to maintain consistency between the ownerships of the entity and the NFT of the artwork.

In a sixth step, in addition to the functions of entity binding and checking, the secondary delivery process of the same system and method for the digital artwork NFT issued according to this specification can also be applied to wallet backup, to provide the effect of preventing the holder's wallet from being lost. The implementation example will be described in the following paragraphs.

1. A first wallet of the holder of the artwork NFT is set as the secondary delivery transmitter, and a second wallet of the same holder is set as the secondary delivery receiver.

2. The first wallet initiates a secondary delivery to specify the second wallet as a receiver, and set a future time (such as, 23:59:59 on Dec. 15, 2021) that is far away from the present time as the delivery timeout, and the operation of setting the delivery condition is the same as that of the above-mentioned fourth step.

3. When the holder's first wallet is lost or cannot be accessed, if the holder still holds the physical IC card, the holder can use the second wallet and the physical chip card to complete the second delivery to the second wallet that is still under the holder's control through the operation the same that of the above-mentioned fifth step, so as to achieve the effect of retrieving the artwork NFT when the first wallet is lost.

4. When the first wallet is stolen by hackers rather than lost, the hackers who have the ability to access the first wallet is unable to transfer the artwork NFT because of not holding the artwork entity IC card. At this time, the holder can also transfer the artwork NFT to another second wallet whose content has not been stolen, so as to achieve the effect of double protection of ownerships of the NFT and the entity of the artwork.

It is to be particularly noted that, when the artwork is a digital painting, the digital content is stored in a gallery server and displayed on a dedicated display frame, such as a electronic showcase. After the secondary delivery receiver receives the artwork, the secondary delivery receiver host 620 can divide the digital painting into multiple parts, and encrypts one of the divided parts with a receiver public-key to generate an encrypted extraction content and writes the encrypted extraction content into the NFT smart contract to form or update attributes of the artwork NFT, and update the digital content in the new gallery server to be the incomplete version in which a part is extracted. In order to display the digital painting on the electronic showcase, the ownerships of the aforementioned IC card and the NFT are checked, and the encrypted extraction content of the artwork NFT stored in the NFT smart contract is also decrypted by the secondary receiver (that is, the current holder), and the decrypted extraction encrypted extraction content is merged with the incomplete version stored in the gallery server, so as to restore the complete digital painting for display.

In an embodiment, in a condition that the product is a trading card, the product NFT corresponding to the trading card is executed when the initial register function is executed, and the process is described in the following paragraphs.

1. A trading card issuance company deploys a trading card NFT contract (that is, NFT smart contract), the contract includes the basic functions of the NFT (such as a function of recording an owner of the trading card), an initial register function and a secondary delivery function. The initial register function has a trading card issuance company public key (that is, a product issuance public-key).

2. When issuing the trading card, the trading card issuance company also prepares the necessary data (that is, the necessary data 410) required for the trading card to perform initial register; for example, the necessary data can include a trading card public-key (that is, a product public-key), and a valid check string “0”. The register necessary data is encrypted with the trading card issuance company private-key (that is, the product issuance private-key 420), to generate the encrypted register content (that is, the encrypted product content 430). The additional information in the form of QR code is printed on each trading card; for example, the additional information includes the encrypted register content and a trading card private-key.

3. When the owner buying the trading card product obtains the trading card entity and does not perform the initial register, the owner is set as the initial register end to use the scan application program provided by trading card company to obtain the encrypted register content from the QR code on the trading card, and submit the content to the initial register function of the trading card NFT contract, so as to perform the initial register of the trading card. The initial register function uses the trading card issuance company public-key to decrypt content and checks whether the decrypted content satisfies the specification of the trading card issuance company, that is, the valid check string “0”; when a result of the check passes, a trading card NFT (that is, the product NFT) is generated in the contract, and the public key of the trading card is registered in this trading card NFT, so as to set the ownership of the trading card NFT to the initial register host 120, which is the holder of the trading card.

4. Because the trading card has the nature of collection and exchange, a secondary transaction of the trading card may be performed. In order to perform a secondary transaction on the trading card that has registered, the secondary delivery transmitter host is the current trading card holder and can be the initial register end in the previous step or a final holder of the trading card after multiple secondary transactions, the secondary delivery transmitter host calls the secondary delivery function to specify the trading card NFT to be delivered, the trading card buyer (that is, an address of the secondary delivery receiver host) and a delivery timeout to set a delivery condition; the delivery condition is used to require the secondary delivery receiver to provide the encrypted delivery content, and the encrypted delivery content is decrypted with a receiver public-key and the trading card public-key, in sequential order. The decryption result must be the result “1” defined and specified in plaintext by the secondary delivery function.

5. After receiving the entity of the trading card, the secondary delivery receiver can use the secondary delivery receiver host to encrypt the value “1”, which is specified by the secondary delivery function, with the receiver private-key and the trading card private key obtained from the QR code on the trading card in sequential order to generate the encrypted delivery content, and submit the encrypted delivery content to the secondary delivery function. When the secondary delivery function passes the check and the value of “1” is obtained after decryption according to the delivery condition of the trading card NFT, and the trading card NFT is delivered to the receiver, so as to maintain the consistency between ownerships of the entity and the NFT of the trading card.

In an embodiment, an electronic product (such as 3C product) is taken as an example for illustration. In this example, the product NFT corresponding to the electronic product is generate when the initial register function is executed, and the overall process in this condition will be described in the following paragraphs.

1. A laptop manufacturer deploys a laptop NFT contract (that is, a NFT smart contract), the NFT contract includes basic functions of NFT (such as a function of recording the owner of the laptop), and an initial register function and a secondary delivery function. The initial register function has a laptop manufacturer public-key (that is, a product issuance public-key).

2. While producing the laptop, the laptop manufacturer also prepares necessary data (that is, necessary data 410) required for the initial register of the laptop, the necessary data can include a laptop public key (that is, a product public-key) and a valid check data “status: True”, such as the data of JSON form: {“key”:“AAAAE2 . . . , “status”:1}. The necessary data for register is encrypted with a laptop manufacturer private-key (that is, the product issuance private-key 420) to generate the encrypted register content (that is, the encrypted product content 430). The encrypted register content and the private key are written in the laptop in an unchangeable form, for example, the encrypted register content and the private key are burnt in a read-only memory of the laptop.

3. When a holder who purchases the laptop obtains the laptop and the laptop has not registered, the holder can be set as the initial register end, and the holder uses the laptop manufacturer's firmware or system to obtain the encrypted register content from the ROM of the laptop, and submits the encrypted register content to the initial register function of the laptop NFT contract, and performs the initial register of the laptop. The initial register function decrypts the encrypted register content with the laptop manufacturer public-key and checks whether the decrypted content matches the laptop manufacturer's specifications, that is, to parse the JSON and check whether the JSON contains string “status:”1″”; when a result of the check passes, the laptop NFT (that is, the product NFT) is generated in the contract, the public key “tbml . . . =” is registered in the laptop NFT, the ownership of the laptop NFT is set to the initial register host, which is the owner of the laptop. Therefore, the laptop manufacturer can use the laptop NFT as a basis for providing firmware updates or other online services, or use the register record as a warranty condition or time record.

4. The laptop may perform a secondary transaction. To perform a secondary transaction of the laptop that has registered, the secondary delivery transmitter host is the current holder of the laptop, and can be the initial register end in the previous step, or the latest holder of the laptop after multiple secondary deliveries; the holder uses the laptop manufacturer's firmware or system to call the secondary delivery function to specify the laptop NFT to be delivered, the laptop buyer (that is, the secondary delivery receiver address), and a delivery timeout to set the delivery condition. The delivery condition is used to require the receiver to provide the encrypted delivery content, and encrypted delivery content is decrypted with the receiver public-key and public key of the laptop, in sequential order. The decryption result should be the result in a form of JSON {“transfer”:1}, which is defined and specified in plaintext by the secondary delivery function.

5. After receiving the laptop, the secondary delivery receiver uses the laptop manufacturer's firmware or system to encrypt the JSON {“transfer”:1} specified by the secondary delivery function with the receiver private-key and the laptop private key stored in the read-only memory of the laptop in sequential order, to generate the encrypted delivery content, and submits the encrypted delivery content to the secondary delivery function. When the secondary delivery function passes the check and JSON {“transfer”:1} is obtained after decryption according to the delivery condition of the laptop NFT, the laptop NFT is delivered to the receiving end, so as to maintain the consistency between the ownerships of the entity and NFT of the laptop. Based on the laptop NFT, the new holler of the laptop can continue to use various rights and interests related to the laptop, such as update service or online services, and other software and hardware rights. This embodiment is the service authorization tied to the hardware.

According to above-mentioned contents, the difference between the present invention and the conventional technology is that in the present invention, the NFT smart contract is deployed on the blockchain network, and the product NFT is generated before or while the initial register function of the NFT smart contract is executed, the initial register function is permitted to transfer the ownership of the product NFT when being executed; when the product performs the secondary transaction, the secondary delivery transmitter host executes the secondary delivery function to set the delivery condition and requests the secondary delivery receiver host to provide the encrypted delivery content; when the product is delivered and the encrypted delivery content satisfies the delivery condition, the ownership of the product NFT is transferred. Therefore, the above-mentioned technical solution of the present invention is able to solve the conventional problem, to achieve the technical effect of improving consistency between ownerships of an entity and a product NFT of a virtual-real coupling product.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An initial issuance and secondary delivery system for a non-fungible token (NFT) and an entity of a virtual-real coupling product, and the initial issuance and secondary delivery system comprising:
a product issuance host, wherein the product issuance host is one of nodes of a blockchain network, and the product issuance host comprises:
a deploy module, configured to deploy a NFT smart contract on the blockchain network, wherein the NFT smart contract comprises an initial register function and a secondary delivery function, the initial register function stores a product issuance public-key, and is permitted generate a product NFT corresponding to a product before or while the initial register function is executed; and
a production module, connected to the deploy module, wherein when the product is produced, the production module encrypts necessary data of the product with a product issuance private-key to generate an encrypted product content, embeds the encrypted product content and a product private-key into the product or an entity device corresponding to the product, wherein the necessary data comprises a product public-key;
an initial register host, wherein the initial register host is one of the nodes of the blockchain network, and when an initial register is performed on the product, initial register host obtains the encrypted product content from the product or the entity device and transmits the encrypted product content to the initial register function, so that the initial register function decrypts the encrypted product content with the stored product issuance public-key to obtain a first decrypted content, and when the product NFT is not produced yet, the initial register function generates the product NFT corresponding to the product, and when the first decrypted content matches the necessary data, the initial register function transfers an ownership of the product NFT to the initial register host, to complete the initial register;
a secondary delivery transmitter host, wherein the secondary delivery transmitter host is one of the nodes of the blockchain network, and when a secondary delivery is performed on the product NFT which has completed the initial register, the secondary delivery transmitter host calls the secondary delivery function to specify the product NFT to be delivered, a secondary delivery receiver address and a delivery timeout as a delivery condition, and request a secondary delivery receiver host to provide an encrypted delivery content based on the secondary delivery receiver address; and
the secondary delivery receiver host, wherein the secondary delivery receiver host is one of the nodes of the blockchain network, and after the product or the entity device corresponding to the product is delivered to the secondary delivery receiver host, the secondary delivery receiver host encrypts specification information, which is preset by the secondary delivery function, with a receiver private-key and the obtained product private-key in a sequential order, to generate the encrypted delivery content and transmit the encrypted delivery content to the secondary delivery function, so that the secondary delivery function decrypts the encrypted delivery content with the product public-key and a receiver public-key in a sequential order, to obtain a second decrypted content, and when the second decrypted content matches the specification information and the delivery timeout is not exceeded, it indicates that the delivery condition is satisfied, an ownership of the product NFT is transferred to the secondary delivery receiver host, so as to maintain consistency between ownerships of the product and the product NFT.

2. The initial issuance and secondary delivery system for a non-fungible token (NFT) and an entity of a virtual-real coupling product according to claim 1, wherein when the product is a digital content, the secondary delivery receiver host is permitted to divide the digital content into a plurality of content fragments, perform extraction and offsite storage on at least one of the plurality of content fragments, encrypt the extracted content fragment with the receiver public-key to generate an encrypted extraction content, and write the encrypted extraction content into the NFT smart contract, wherein when the secondary delivery is performed again, an owner of the product NFT decrypts and recovers the encrypted extraction content, or encrypts the encrypted extraction content with the receiver public-key to generate another encrypted extraction content.

3. The initial issuance and secondary delivery system for a non-fungible token (NFT) and an entity of a virtual-real coupling product according to claim 1, wherein the encrypted product content and the product private-key are converted into a QR code first and the QR code is embedded into the product or the entity device corresponding to the product, or the encrypted product content and the product private-key are directly embedded into the product or the entity device corresponding to the product, wherein the entity device is a smart IC card or a wireless RFID tag.

4. The initial issuance and secondary delivery system for a non-fungible token (NFT) and an entity of a virtual-real coupling product according to claim 1, wherein when the second decrypted content does not match the specification information or the delivery timeout is exceeded, it indicates that the delivery condition is not satisfied, and the ownership of the product NFT is prohibited from be changed.

5. The initial issuance and secondary delivery system for a non-fungible token (NFT) and an entity of a virtual-real coupling product according to claim 1, wherein the product is displayed on an electronic display cabinet or an electronic showcase, and before the product is displayed on the electronic display cabinet or the electronic showcase, the ownership of the product NFT is checked whether to match the product private-key in the entity device.

6. An initial issuance and secondary delivery method for a non-fungible token (NFT) and an entity of a virtual-real coupling product, and the initial issuance and secondary delivery method comprising:
providing a product issuance host, an initial register host, a secondary delivery transmitter host and a secondary delivery receiver host which are nodes of a blockchain network;
deploying a NFT smart contract on the blockchain network, by the product issuance host, wherein the NFT smart contract comprises an initial register function and a secondary delivery function, the initial register function stores a product issuance public-key and is permitted to generate a product NFT corresponding to a product before or while the initial register function is executed;
when the product issuance host produces the product, encrypting necessary data of the product with a product issuance private-key to generate an encrypted product content, embedding the encrypted product content and a product private-key into the product or an entity device corresponding to the product, wherein the necessary data comprises a product public-key;
when an initial register is performed on the product, obtaining the encrypted product content from the product or the entity device and transmitting the encrypted product content to the initial register function, by the initial register host, wherein the initial register function decrypts the encrypted product content with the stored product issuance public-key to obtain a first decrypted content, wherein when the product NFT is not produced yet, the initial register function generates the product NFT corresponding to the product, and when the first decrypted content matches the necessary data, the initial register function transfers an ownership of the product NFT to the initial register host, to complete the initial register;
when a secondary delivery is performed on the product NFT which had completed the initial register, setting a current owner of the product NFT as the secondary delivery transmitter host, and calling the secondary delivery function to specify the product NFT to be delivered, a secondary delivery receiver address and a delivery timeout as a delivery condition, and request the secondary delivery receiver host to provide an encrypted delivery content based on the secondary delivery receiver address; and
after the product or the entity device corresponding to the product is delivered to the secondary delivery receiver host, encrypting specification information, which is preset by the secondary delivery function, with a receiver private-key and the obtained product private-key in sequential order to generate the encrypted delivery content, and transmitting the encrypted delivery content to the secondary delivery function, by the secondary delivery receiver host, wherein the secondary delivery function decrypts the encrypted delivery content with the product public-key and a receiver public-key in sequential order to obtain a second decrypted content, wherein when the second decrypted content matches the specification information and the delivery timeout is not exceeded, it indicates that the delivery condition is satisfied, an ownership of the product NFT is transferred to the secondary delivery receiver host, so as to maintain consistency between ownerships of the product and the product NFT.

7. The initial issuance and secondary delivery method for a non-fungible token (NFT) and an entity of a virtual-real coupling product according to claim 6, wherein when the product is a digital content, the secondary delivery receiver host is permitted to divide the digital content into a plurality of content fragments, perform extraction and offsite storage on at least one of the plurality of content fragments, encrypt the extracted content fragment with the receiver public-key to generate an encrypted extraction content, and write the encrypted extraction content into the NFT smart contract, wherein when the secondary delivery is performed again, an owner of the product NFT decrypts and recovers the encrypted extraction content, or encrypt the encrypted extraction content with the receiver public-key to generate another encrypted extraction content.

8. The initial issuance and secondary delivery method for a non-fungible token (NFT) and an entity of a virtual-real coupling product according to claim 6, wherein the encrypted product content and the product private-key are converted into a QR code first and the QR code is embedded into the product or the entity device corresponding to the product, or the encrypted product content and the product private-key are directly embedded into the product or the entity device corresponding to the product, wherein the entity device is a smart IC card or a wireless RFID tag.

9. The initial issuance and secondary delivery method for a non-fungible token (NFT) and an entity of a virtual-real coupling product according to claim 6, wherein when the second decrypted content does not match the specification information or the delivery timeout is exceeded, it indicates that the delivery condition is not satisfied, and the ownership of the product NFT is prohibited from being changed.

10. The initial issuance and secondary delivery method for a non-fungible token (NFT) and an entity of a virtual-real coupling product according to claim 6, wherein the product is displayed on an electronic display cabinet or an electronic showcase, and before the product is displayed on the electronic display cabinet or the electronic showcase, the ownership of the product NFT is checked whether to match the product private-key in the entity device.
